(19) United States
(12) Patent Application Publication
(10) Pub. No.: US 2014/0007628 A1
(43) Pub. Date: Jan. 9, 2014

(54) ELECTRONIC LOCKING DEVICE FOR SECURING GOODS

(71) Applicant: Entreprises Mobilock Inc., Terrebonne (CA)

(72) Inventors: Christian Beaulieu, Blainville (CA); Mario Coderre, Terrebonne (CA)

(21) Appl. No.: 13/936,721

(22) Filed: Jul. 8, 2013

Related U.S. Application Data
(60) Provisional application No. 61/668,620, filed on Jul. 6, 2012.

(51) Int. Cl. E05B 67/00

(52) U.S. Cl. CPC E05B 67/003
USPC 70/18

(57) ABSTRACT

The present document describes an electronic locking device for securing goods comprising: a locking mechanism; an electrically conductive link used for forming a closed loop to the locking mechanism for securing the goods and for forming a closed electrical circuit; and a mobile communication device connected to the closed electrical circuit and being in communication with at least one of a plurality of access points of an external network, the external network sending an advisory message upon tampering with at least one of the closed electrical circuit, the mobile communication device and the locking mechanism.

### CROSS-REFERENCE TO RELATED APPLICATIONS

This application claims priority under 35 USC §119(e) of U.S. provisional patent application 61/668,620 filed on Jul. 6, 2012, the specification of which is hereby incorporated by reference.

### BACKGROUND

(a) Field

The subject matter disclosed generally relates to the field of locking devices for securing goods. More particularly, the subject matter relates to electronic locking devices for securing goods.

(b) Related Prior Art

Following an important study, it has been demonstrated that the lack of security on construction sites may lead to direct and indirect annual losses estimated to approximately 100 millions $ in Canada and to 1 billion $ in the United States. Studies also revealed that about 75% of stolen equipment on construction sites are tools and building materials, that 60% of construction sites in operation have been stolen in the last 2 years, and that 72% of sites have been stolen more than five times in 3 years.

Construction sites and buildings need to be protected during construction with adequate devices to protect heavy equipment, such as, without limitation, machinery, construction trailers, containers, miscellaneous equipments and the like. These construction sites also need protection against elements, such as fire, water infiltration or vandalism. The same problems apply to any equipment which is mobile such as, without limitation, bicycles, motorcycles, boats, heavy bags or casings and the like. In fact, these problems apply to any goods which can be secured using conventional locking devices.

A lot of locking devices now on the market are available for these specific purposes. However, these locking devices often includes deficiencies such as, without limitation, permanently fixed equipment, fixed permanent control panels, intervention of a technician to change the components and the like.

There is therefore a need for an improved electronic locking device for securing goods.

### SUMMARY

According to an embodiment, there is provided an electronic locking device for securing goods comprising: a locking mechanism; an electrically conductive link used for forming a closed loop to the locking mechanism for securing the goods and for forming a closed electrical circuit; and a mobile communication device connected to the closed electrical circuit and being in communication with at least one of a plurality of access points of an external network, the external network sending an advisory message upon tampering with at least one of the closed electrical circuit, the mobile communication device and the locking mechanism.

According to another embodiment, the electronic locking device further comprises a casing comprising a main frame and a cover portion releasably connected to the main frame, the main frame receiving the locking mechanism and at least a portion of the electrically conductive link on one side and the mobile communication device on another side, the cover portion for covering at least one of: the locking mechanism, the at least a portion of the electrically conductive link and the mobile communication device.

According to a further embodiment, the electronic locking device further comprises an electronic circuit board for receiving at least one of: the locking mechanism, at least a portion of the electrically conductive link and the mobile communication device.

According to yet another embodiment, the electronic locking device further comprising a power supply integrated on the electronic circuit board.

According to another embodiment, the electronic circuit board further includes a power supply status indicator for indicating a power proportion remaining for operating the electronic locking device.

According to a further embodiment, the power supply status indicator comprises a LED.

According to yet another embodiment, the locking mechanism comprises one of: a mechanical locking mechanism, an electromechanical locking mechanism, a digital locking mechanism, a removable key locking mechanism, a combination locking mechanism, a magnetic locking mechanism, a card reader locking mechanism, a cam locking mechanism, a child safety locking mechanism, a keycard locking mechanism, a time locking mechanism and any combination thereof.

According to another embodiment, the electrically conductive link comprises: an internal cable having two ends to be coupled with the locking mechanism, the internal cable defining a length; an electrically conductive cable for at least partially covering the internal cable along its length, the electrically conductive cable for forming the closed loop to the locking mechanism and for forming the closed electrical circuit; and a protective cable for covering the internal cable and the electrically conductive cable, the protective cable being made of a material defining high strength properties.

According to a further embodiment, the internal cable is made of a lifting cable and further wherein the material of the protective cable comprises a para-aramid synthetic fiber.

According to yet another embodiment, the external network allows sms communication, radio frequency communication and cellular communication.

According to another embodiment, the mobile communication device further includes a GSM card for storing and communicating information with the external network.

According to a further embodiment, the electronic locking device further comprises a GPS integrated device on one of: the locking mechanism, at least a portion of the electrically conductive link and the mobile communication device.

According to yet another embodiment, the electronic locking device further comprises a communication push button for communicating information in real time with the external network.

According to another embodiment, the mobile communication device further includes a mobile communication indicator for indicating a mobile communication reception level for operating the electronic locking device.

According to a further embodiment, the electronic locking device further comprises an alarm device connected to the mobile communication device for emitting an alarm when the external network sends the advisory message upon tampering with at least one of the closed electrical circuit, the mobile communication device and the locking mechanism.

According to yet another embodiment, the mobile communication device comprises at least one of: a wireless mobile communication device, a cellular mobile communication device and a radio frequency communication device.

According to another embodiment, there is provided an electronic locking device for securing goods comprising: a locking mechanism; an electrically conductive link used for forming a closed loop to the locking mechanism for securing the goods and for forming a closed electrical circuit; and an electronic circuit board for electrically connecting the locking mechanism and the electrically conductive link, the electronic circuit board having: a mobile communication device connected to the closed electrical circuit and in communication with at least one of a plurality of access points of an external network, the external network sending an advisory message upon tampering with at least one of the closed electrical circuit, the mobile communication device and the locking mechanism; and a power supply for operating the mobile communication device.

According to a further embodiment, the mobile communication device comprises at least one of: a wireless mobile communication device, a radio frequency communication device and a cellular mobile communication device.

According to another embodiment, there is provided an electrically conductive link for forming a closed loop to a locking mechanism of an electronic locking device for securing the goods, the electrically conductive link comprising: an internal cable having two ends to be coupled with the locking mechanism, the internal cable defining a length; an electrically conductive cable for at least partially covering the internal cable along its length, the electrically conductive cable for forming the closed loop to the locking mechanism and for forming a closed electrical circuit; and a protective cable for covering the internal cable and the electrically conductive cable, the protective cable being made of a material defining high strength properties.

According to a further embodiment, the material of the protective cable comprises a para-aramid synthetic fiber.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a perspective view of a cover portion of an electronic locking device in accordance with an embodiment;

FIG. 2 is a perspective view of a main frame of an electronic locking device in accordance with another embodiment;

FIG. 3 is another perspective view of the main frame of the electronic locking device of FIG. 2;

FIG. 4 is an exploded perspective view of the main frame and of the cover portion of FIGS. 1-3;

FIG. 5 is a side elevation view of the electronic locking device of FIG. 4;

FIG. 6 is a perspective view of another cover portion of an electronic locking device in accordance with another embodiment;

FIG. 7A is a perspective view of an electrically conductive link in accordance with another embodiment, showing an internal cable;

FIG. 7B is a perspective view of an electrically conductive link in accordance with another embodiment, showing an internal cable and an electrically conductive cable;

FIG. 7C is a perspective view of an electrically conductive link in accordance with another embodiment, showing an internal cable, an electrically conductive cable and a protective cable;

FIG. 8 is a schematic representation of an electronic locking device in accordance with another embodiment;

FIG. 9 is a schematic representation of an electronic locking device in accordance with another embodiment;

FIG. 10A is a schematic representation of the electronic locking device of FIG. 8, in which the closed electrical circuit has been forced or damaged;

FIG. 10B is a schematic representation of the electronic locking device of FIG. 8, in which the mobile communication device has been forced or damaged; and

FIG. 10C is a schematic representation of the electronic locking device of FIG. 8, in which the locking mechanism has been forced or damaged.

It will be noted that throughout the appended drawings, like features are identified by like reference numerals.

### DETAILED DESCRIPTION

In embodiments there are disclosed electronic locking devices for securing goods and electronic locking cables for electronic locking devices.

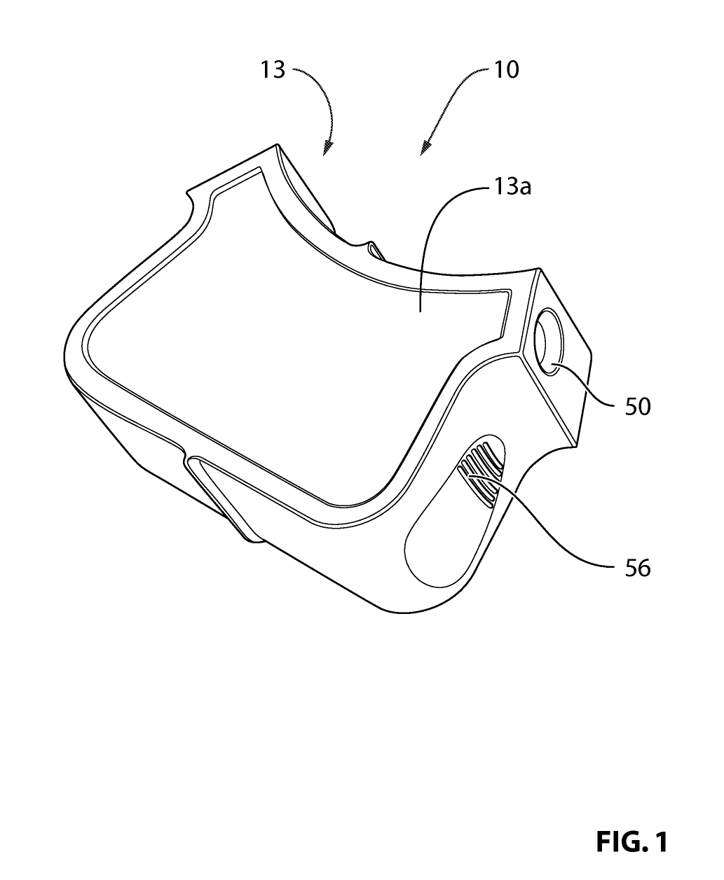

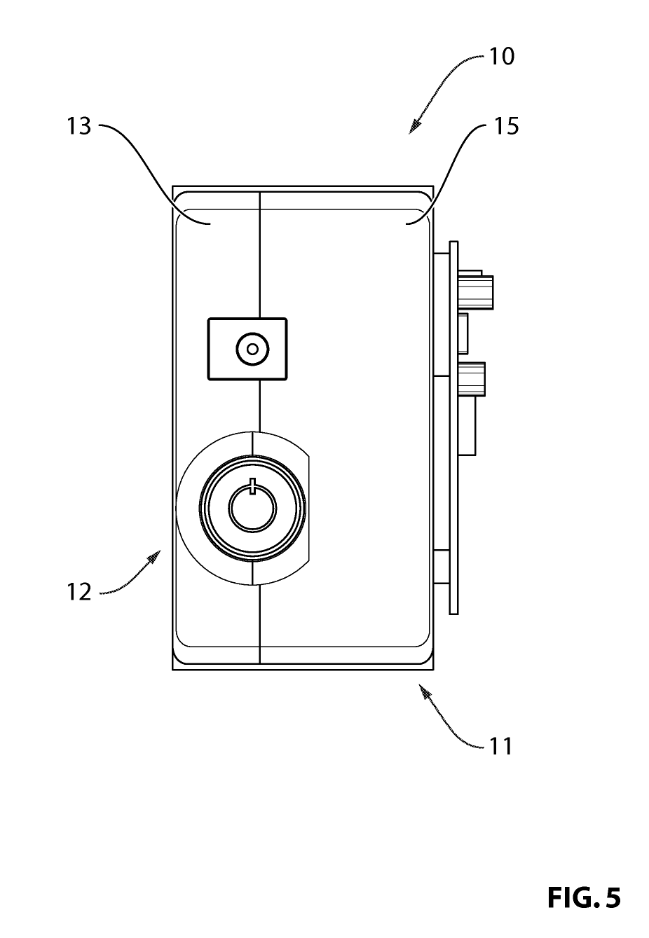

Referring now to the drawings and more particularly to FIGS. 1-7C, there is shown an electronic locking device 10 for securing goods. The electronic locking device 10 includes a casing 11. The casing 11 includes a main frame 15 and a cover portion 13 which is releasably connected to the main frame 15. The electronic locking device 10 further includes a locking mechanism 12 and an electrically conductive link 14 used for forming a closed loop to the locking mechanism 12 for securing the goods and for forming a closed electrical circuit. The electronic locking 10 device also includes an electronic circuit board 28 for electrically connecting the locking mechanism 12 and the electrically conductive link 14. The electronic circuit board 28 includes a mobile communication 20 device connected to the closed electrical circuit and in communication with at least one of a plurality of access points of an external network. Thus, the external network may send an advisory message upon tampering with at least one of the closed electrical circuit, the mobile communication device 20 and the locking mechanism 12. The electronic circuit board 28 also includes a power supply 30 for operating the mobile communication device 20.

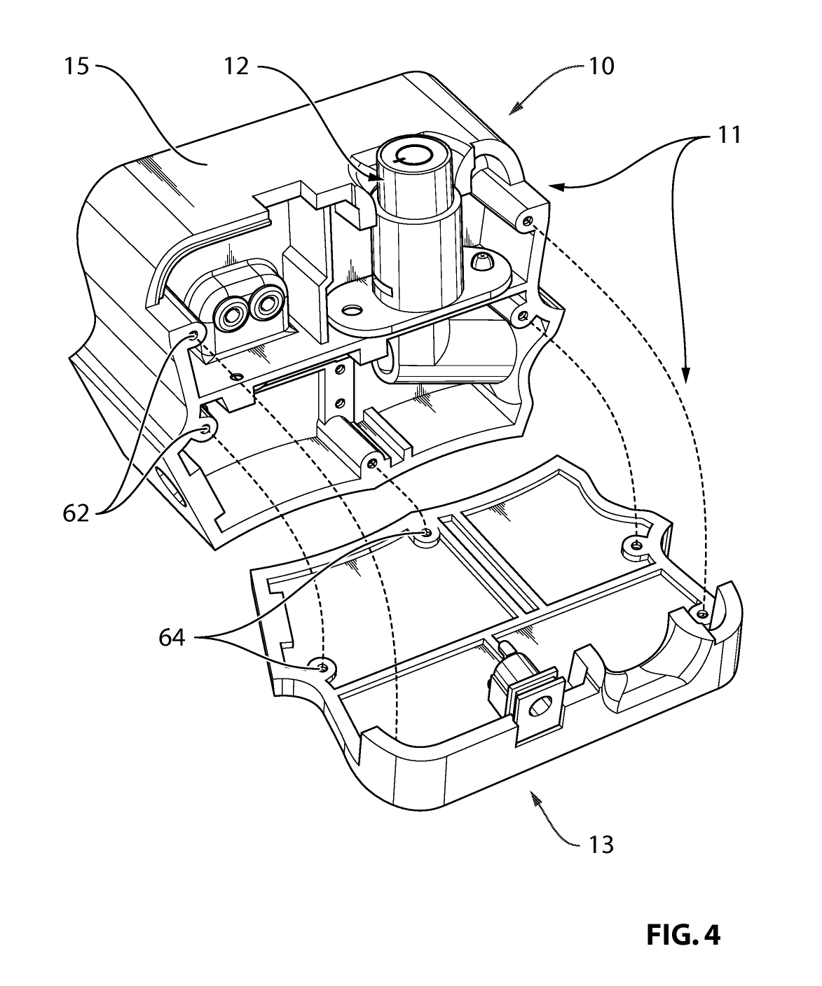

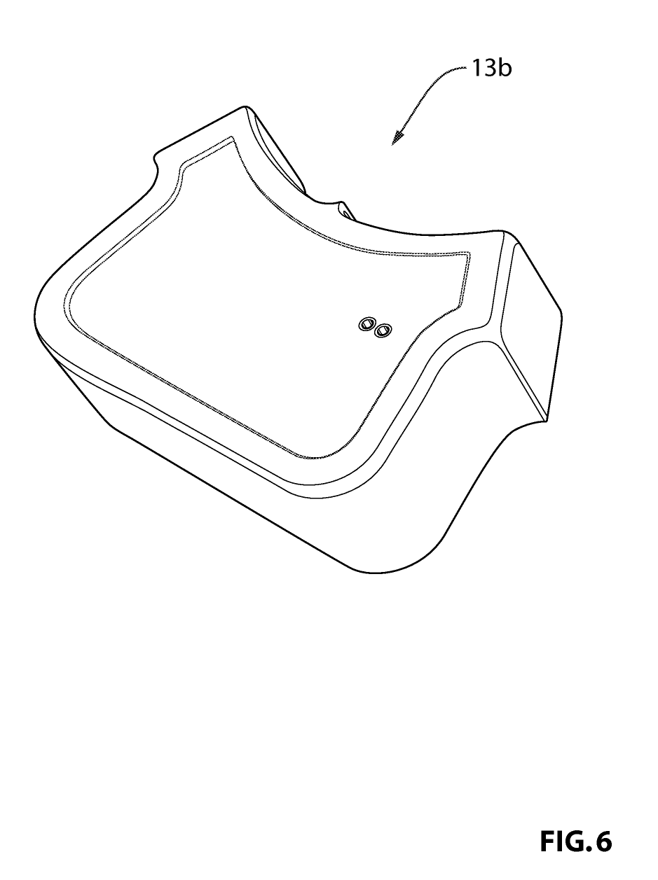

The main frame 15 of the electronic locking device 10 receives the locking mechanism 12 and at least a portion of the electrically conductive link 14 on one side 21 and the mobile communication device 20 on another side 23. The cover portion 13 covers at least one of the locking mechanism 12, the at least a portion of the electrically conductive link 14 and the mobile communication device 20. As shown in FIGS. 1, 4 and 6, the electronic locking device 10 includes a first cover portion 13a for covering the locking mechanism 12 and at least a portion of the electrically conductive link 14 on the first side 21 (FIGS. 1 and 4) of the main frame 15. On the other hand, the electronic locking device 10 includes a second cover portion 13b (FIG. 6) for covering the mobile communication device 20 on the other side 23 of the main frame 15. The main frame 15, the first cover portion 13a and/or the second cover portion 13b may include a plastic material, a metallic material, both, or any suitable material. The first and second cover portions 13a, 13b are releasably or fixedly connected or mounted to the main frame 15. It is to be noted that, since the main frame 15 with the second cover portion 13b cover the mobile communication device 20, the second cover portion 13b may be removed or detached from the main frame 15 via the interior of the electronic locking device 10 such as to render difficult to a thief to access the mobile communication device 20 or to demount the second cover portion 13b from the main frame 15. It is to be noted that the main frame 15, the first cover portion 13a and/or the second cover portion 13b may further include an anti-perforation layer (not shown) which allows the user of the electronic locking device 10 to be informed when someone starts to perforate the main frame 15, the first and/or the second cover portions 13a, 13b (i.e., informed via a sound signal or via an advisory message). The anti-perforation layer may be separated or connected to the closed electrical circuit 18. It is to be noted that the anti-perforation layer may be glued to at least part of the electronic locking device 10 or integrally formed with it. A power supply status indicator 36 for indicating a power proportion remaining 38 for operating the electronic locking device 10 may be found on the second cover portion 13b, and more particularly, on the anti-perforation layer covering the second cover portion 13b.

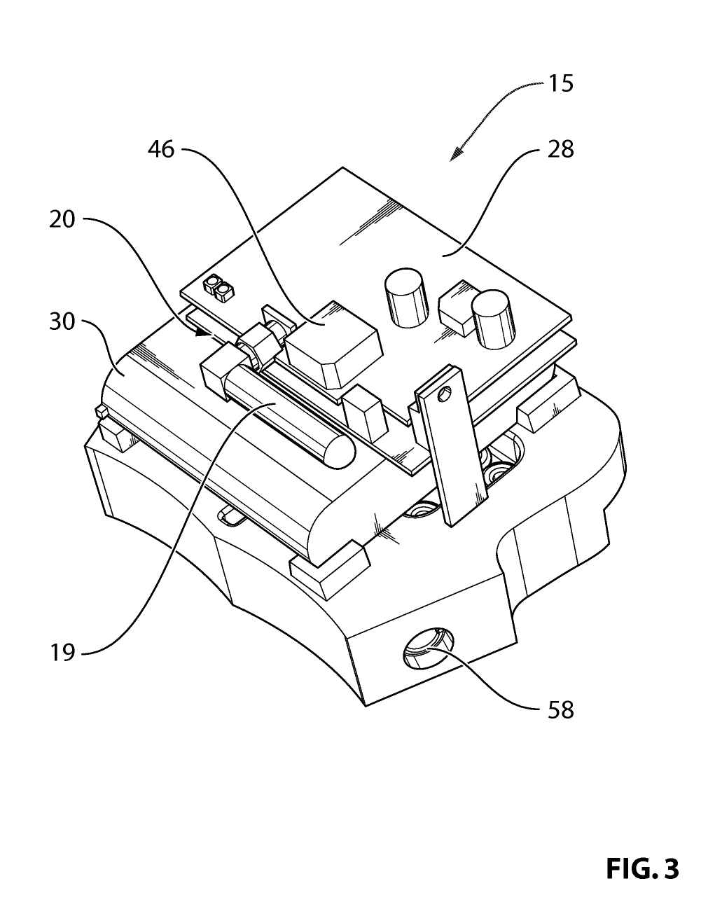

According to another embodiment and referring to FIG. 3, an antenna 19 may be found under the second cover portion 13b, above the second cover portion 13b or below the anti-perforation layer (i.e., the antenna may also be embedded within the anti-perforation layer). A groove within the second cover portion 13b may also receive the antenna 19 to be covered by the anti-perforation layer. It is also to be noted that the electrically conductive link 14 may function as the antenna 19.

As better shown in FIG. 1, the cover portion 13 includes at least an opening for receiving an end 52 of the electrically conductive link 14. The cover portion 13 further includes a gripping portion for allowing a user to better grip and handle the electronic locking device 10. It is to be noted that the shape of the cover portion 13 is such that it fits with the main frame 15 of the electronic locking device 10. The cover portion 13 may also include another opening (not shown) for receiving another end 53 of the electrically conductive link 14.

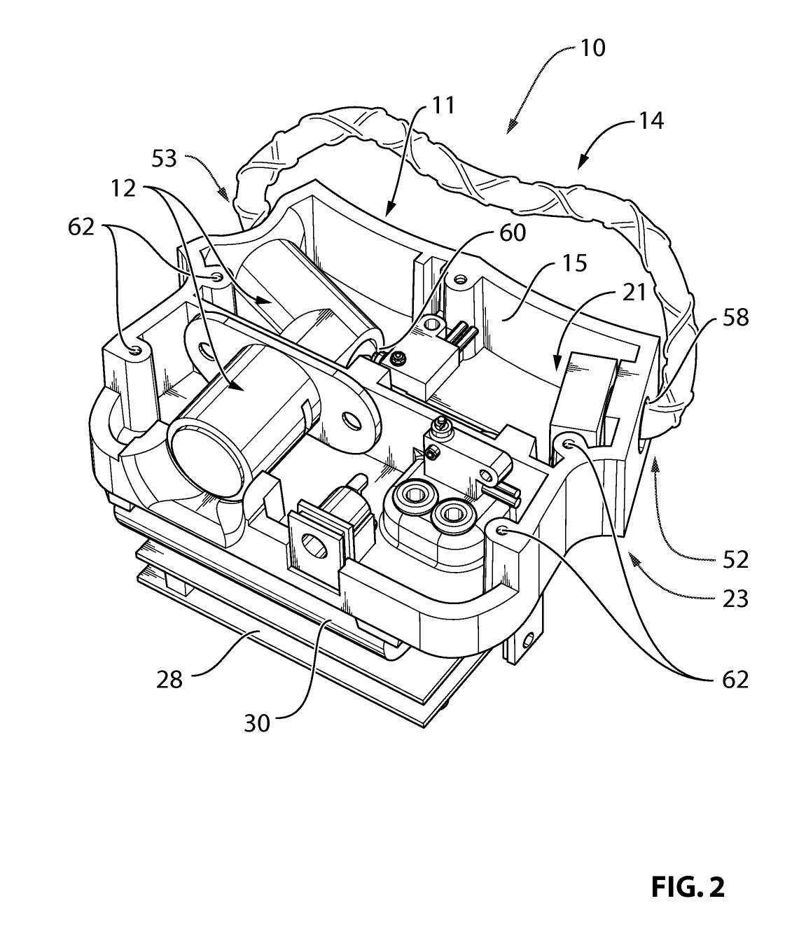

It is to be noted that the ends 52, 53 of the electrically conductive link 14 are configured such as to interlock with receiving interlocking sections 58 located on the main frame 15 of the electronic locking device 10 (FIG. 2). The main frame 15 further includes a mechanical switch for allowing the locking mechanism 12 to be displaced between a locked position (i.e., providing the closed electrical circuit) and an unlocked position (i.e., providing a non-closed electrical circuit). When the locking mechanism 12 is in its unlocked position, no advisory message will be transmitted by the external network since the electronic locking device 10 is used by its user. It is also to be noted that the main frame 15 further includes mating connectors 62 configured to releasably interfacing with the corresponding mating connectors 64 of the cover portion 13.

As shown in FIG. 3, the mobile communication device 20 of the electronic locking device 10 further includes an antenna 19 connected to the closed electrical circuit and in communication with at least one of a plurality of access points of an external network.

In use, a user the ends 52, 53 of the electrically conductive link with the locking mechanism 12 such as to form the closed loop to the locking mechanism 12 for securing the goods and for forming the closed electrical circuit. Then, the user may lock the locking mechanism 12 in its locked position. The external network will send an advisory message upon tampering with at least one of the closed electrical circuit, the mobile communication device 20 and the locking mechanism 12.

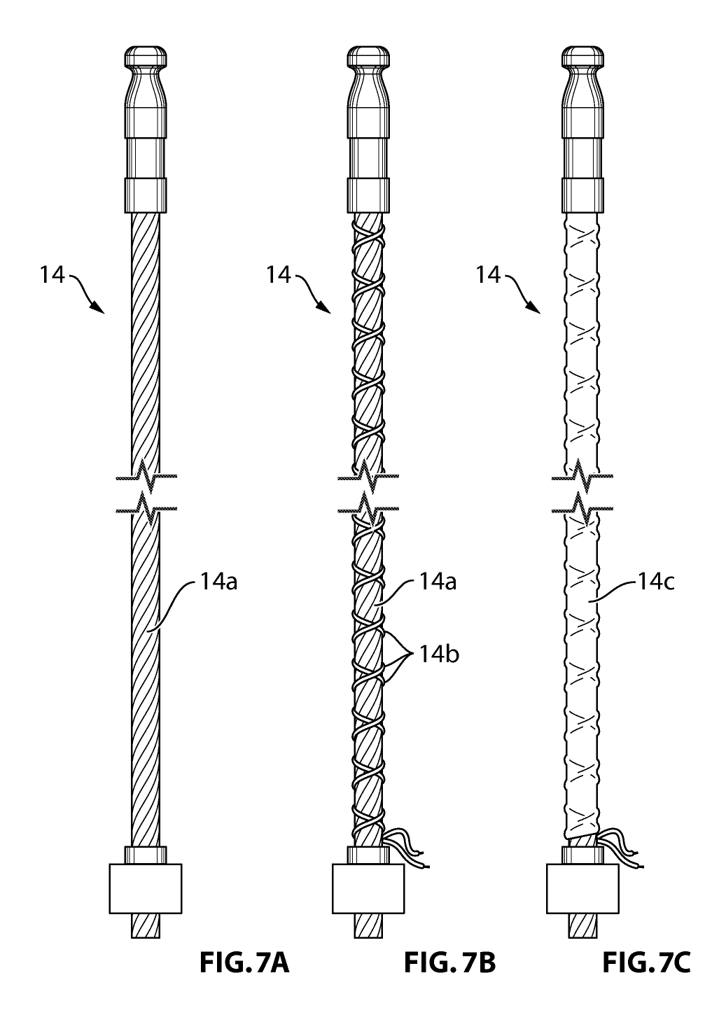

According to another embodiment and referring now to FIGS. 7A-7C, the electrically conductive link 14 includes an internal cable 14a having two ends to be coupled with the locking mechanism 12. The electrically conductive link 14 also includes an electrically conductive cable 14b for at least partially covering the internal cable 14a along its length. The electrically conductive cable 14 is for forming the closed loop 17 to the locking mechanism 12 and for forming the closed electrical circuit 18. Additionally, the electrically conductive link 14 includes a protective cable 14c for covering the internal cable 14a and the electrically conductive cable 14b. The protective cable 14c is made of a material defining high strength properties (i.e., which is hard to cut with cutters or scissors), which render it difficult for a thief to cut it.

FIG. 7A is a perspective view of an electrically conductive link 14 in accordance with another embodiment, showing an internal cable 14a.

FIG. 7B is a perspective view of an electrically conductive link 14 in accordance with another embodiment, showing an internal cable 14a and an electrically conductive cable 14b.

FIG. 7C is a perspective view of an electrically conductive link 14 in accordance with another embodiment, showing an internal cable 14a, an electrically conductive cable 14b and a protective cable 14c.

According to an embodiment, the internal cable 14a is made of a lifting cable and the material of the protective cable 14c includes a para-aramid synthetic fiber, such as, without limitation, Kevlar™. The lifting cable may include steel or any other suitable material.

The electronic locking device 10 may include components made of polymeric material, of metallic material and of any other suitable material. The electronic locking device 10 is configured such as to allow the components to be covered by the cover portion 13 and the main frame 15 such as to allow a user to use his electronic locking device 10 in different conditions (i.e., indoor, outdoor, in the rain, the snow and the like).

The presence of the electrically conductive cable allows the user to be informed in real time when the electrically conductive link 14 is tampered by another person.

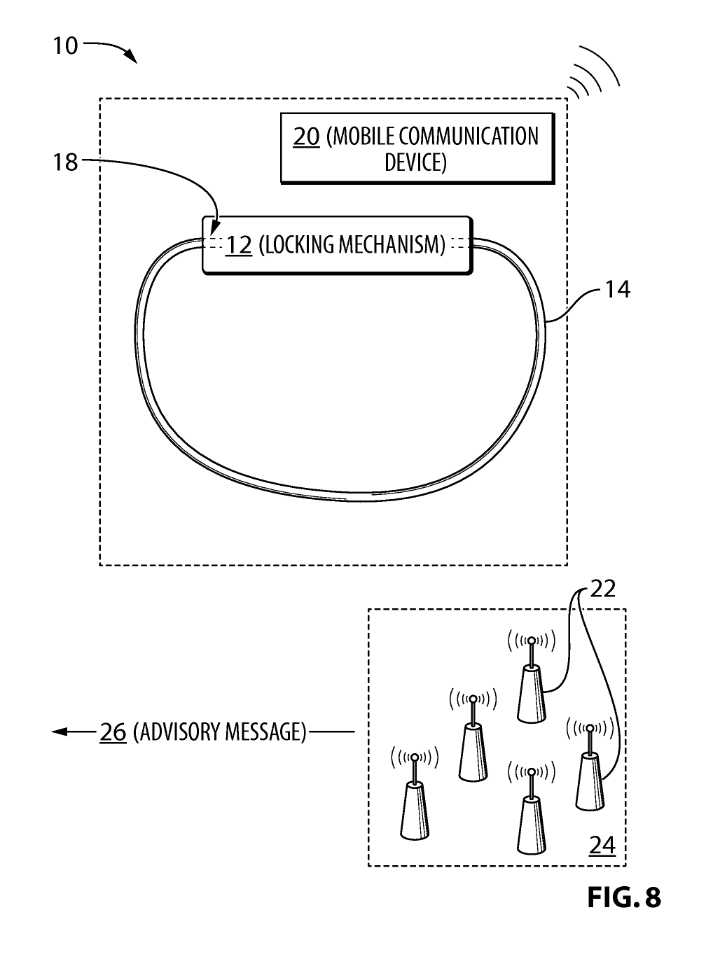

Referring now to FIG. 8, there is shown a schematic electronic locking device 10 for securing goods. The electronic locking device 10 may include a locking mechanism 12 and an electrically conductive link 14 used for forming a closed loop 17 to the locking mechanism 12 for securing the goods and for forming a closed electrical circuit 18. The electronic locking device 10 also includes a mobile communication device 20 connected to the closed electrical circuit 18. The mobile communication device 20 is in communication with at least one of a plurality of access points 22 of an external network 24. The external network 24 is for sending an advisory message 26 upon tampering with at least one of the closed electrical circuit 18, the mobile communication device 20 and the locking mechanism 12.

The advisory message 26 can be sent to a central office or agency, to the mobile device (not shown) of a user/owner of the electronic locking device 10 (i.e., by SMS, by email, by voice message, and the like), or to any other device to which the user/owner of the electronic locking device 10 has access and which will advising him/her of the breach of security.

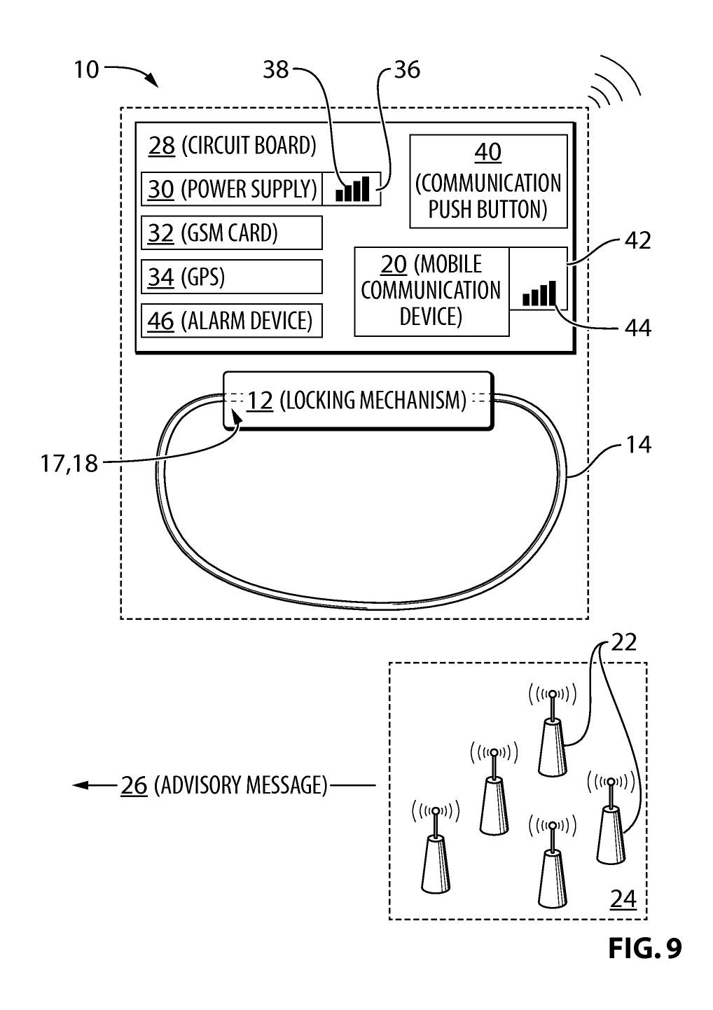

According to another embodiment and referring now to FIG. 9, there is shown that the electronic locking device 10 may further include an electronic circuit board 28 for receiving at least one of: the locking mechanism 12, at least a portion of the electrically conductive link 14 and the mobile communication device 20. The electronic locking device 10 may further include a power supply 30 integrated in the electronic circuit board 28.

According to another embodiment, the locking mechanism 12 of the electronic locking device 10 may include, without limitation, one of: a mechanical locking mechanism, an electromechanical locking mechanism, a digital locking mechanism, a removable key locking mechanism, a combination locking mechanism, a magnetic locking mechanism, a card reader locking mechanism, a cam locking mechanism, a child safety locking mechanism, a keycard locking mechanism, a time locking mechanism, any suitable combination and the like.

According to another embodiment, the electrically conductive link 14 of the electronic locking device 10 may include, without limitation, one of: an electrically conductive chain, an electrically conductive rope, an electrically conductive attach, an electrically conductive line, an electrically conductive fastener, an electrically conductive cable, an electrically conductive wire, any suitable combination and the like.

According to another embodiment, the power supply 30 of the electronic locking device 10 may include, without limitation, one of a regulated power supply, an energy storage power supply, a battery power supply, a fuel cells power supply, a generator power supply, an alternator power supply, a solar power supply, a DC power supply, an AC power supply, a linear regulated power supply, a switched-mode power supply, a programmable power supply, an uninterruptible power supply, a high-voltage power supply, a rechargeable power supply, any combination and the like.

According to another embodiment and still referring to FIG. 9, there is shown that the external network 24 associated with the electronic locking device 10 may allow a sms (i.e., short message service) communication. Additionally, the mobile communication device 20 may further include a GSM card 32 (i.e., global system for mobile communication card) for storing and communicating information with the external network 24. Furthermore, the electronic locking device 10 may further include a GPS integrated device 34 on one of the locking mechanism 12, at least a portion of the electrically conductive link 14 and the mobile communication device 20.

According to another embodiment, the power supply 30 of the electronic locking device 10 may have autonomy of about 20 hours to about 200 hours.

According to another embodiment and still referring to FIG. 9, there is shown that the electronic circuit board 28 of the electronic locking device 10 may further include a power supply status indicator 36 for indicating a power proportion remaining 38 for operating the electronic locking device 10. The power supply status indicator 36 may include a LED (i.e., or a plurality of LED lights) or any other suitable power supply status indicator 36. More particularly, the power supply status indicator 36 may indicate, via a LED, a red color if the power supply is less than 25% or a green color if the power supply is more than 25% or full. The power supply indicator 36 may include one or different colors, may turn on and off and/or may have different shades of its color so as to indicate to a user the proportion of power remaining in the power supply device (i.e., the battery). The locking mechanism 12, the electrically conductive link 14 and the electronic circuit board 28 may operate in a temperature range from about −40° C. to about 40° C. depending of the environment temperature where the electronic locking device 10 is operated. The power supply 30 of the electronic locking device 10 may have autonomy of 2 months and more, depending on the purpose of the electronic locking device 10.

According to another embodiment, the electronic locking device 10 may further include a communication push button 40 (FIG. 9) for communicating information in real time with the external network 24. For example, a continuous exercised pressure of 5 seconds or more on the communication push button 40 may also send an advisory message 26. This situation may include the one that a security guard may need to advise a central communication center of something happening on site, near the electronic locking device 10. The mobile communication device 20 may further integrate a mobile communication indicator 42 for indicating a mobile communication reception level 44 for operating the electronic locking device 10. Also, the electronic locking device 10 as described above may further include an alarm device 46 (FIG. 3) for emitting an alarm when the external network 24 sends the advisory message upon tampering with at least one of the closed electrical circuit 18, the mobile communication device 20 and the locking mechanism 12. It is to be noted that the mobile communication indicator 42 may include one or a plurality of LED lights which indicate the mobile communication reception level. It is also to be noted that the alarm device 46 may be a piezo alarm device or any other suitable alarm device which will emit a sound alarm to indicate that the electronic locking device 10 is being tampered at some point. The piezo alarm may emit at substantially the same time that the advisory message will be sent upon tampering the closed electrical circuit 18, the mobile communication device 20 and/or the locking mechanism 12.

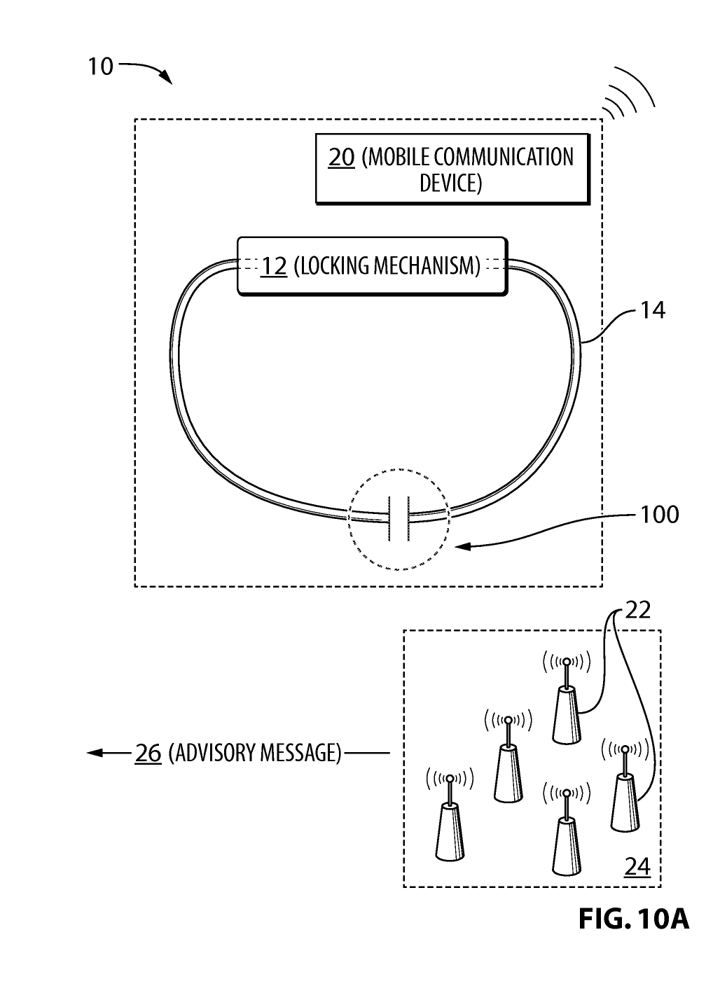

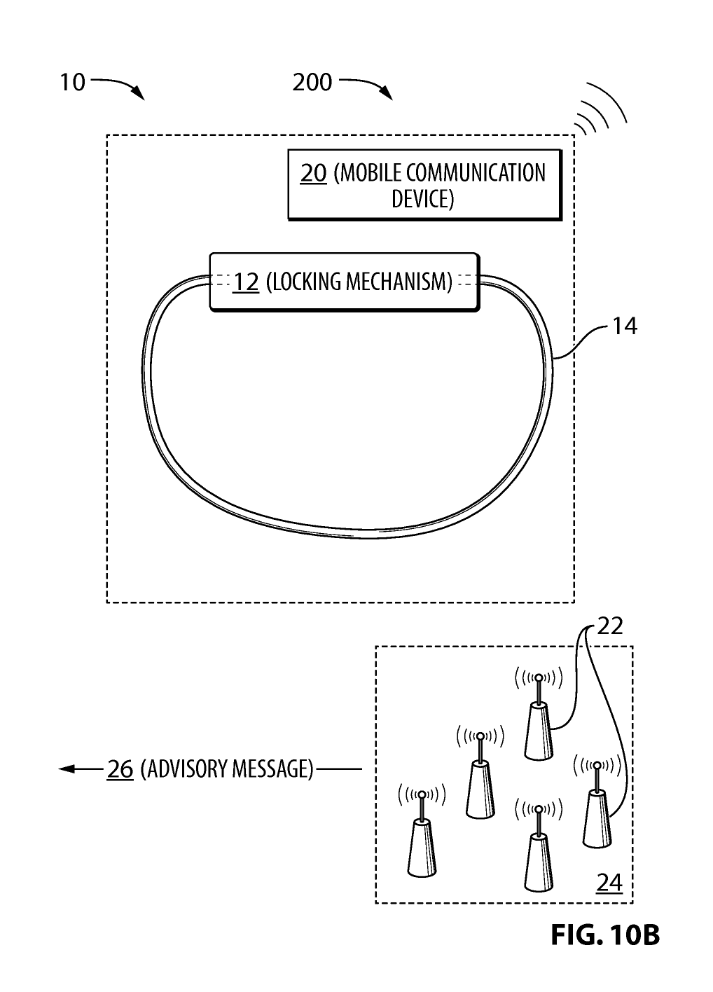

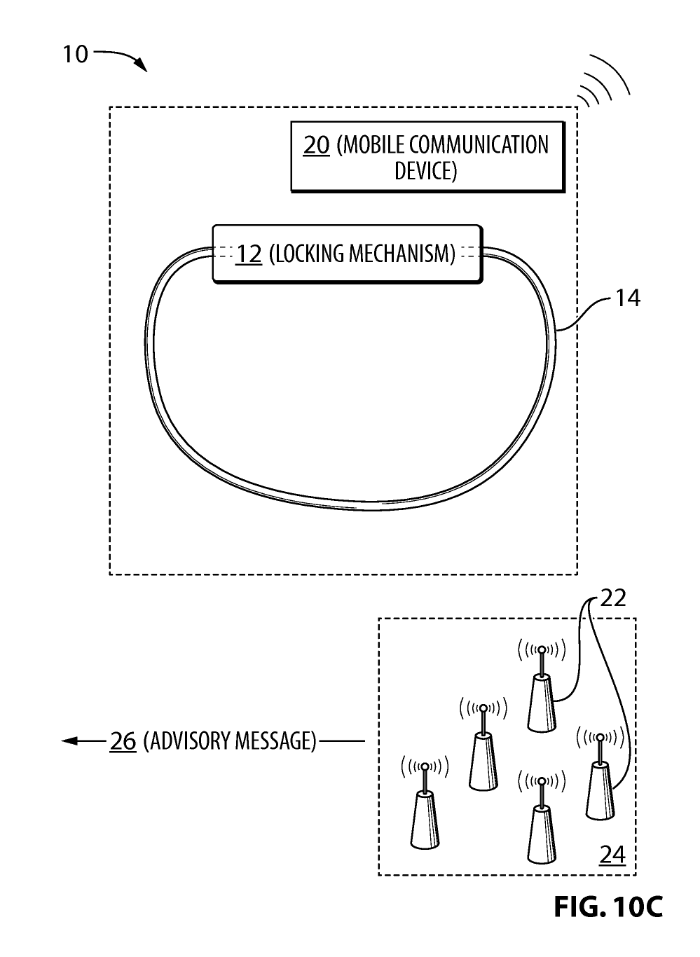

According to another embodiment and referring now to FIG. 10A, there is shown a schematic representation of the electronic locking device 10 of FIG. 1, in which the closed electrical circuit 18 has been forced or damaged in 100. In this way, the external network 24 may send an advisory message 26 upon tampering with the closed electrical circuit 18.

According to another embodiment and referring now to FIG. 10B, there is shown a schematic representation of the electronic locking device 10 of FIG. 8, in which the mobile communication device 20 has been forced or damaged in 200. In this way, the external network 24 may send an advisory message 26, such as a sms communication or a phone communication to a user, upon tampering with the mobile communication device 20.

According to another embodiment and referring now to FIG. 10C, there is shown a schematic representation of the electronic locking device 10 of FIG. 8, in which the locking mechanism 12 has been forced or damaged in 300. In this way, the external network may send an advisory message 26 upon tampering with the locking mechanism 12.

More particularly, the GSM card 32 may be compatible with a mobile network as the external network 24 and may be included in the group consisting of, without limitation, Bell Mobility, Solo, Rogers Wireless, Fido, Chatr, Telus Mobility, Mike, Clearnet, Koodo, Sask Tel Mobility, MTS Mobile, Videotron Cellulaire, Mobilicity, Public Mobile, Virgin Mobile, AT&T, Verizon Wireless, AT&T Mobility, Sprint Nextel, Sprint Network, Nextel Network, Boost Mobile, Virgin Mobile USA, Assurance Wireless, T-Mobile USA, TracFone Wireless, NET10, Straight Talk, SafeLink Wireless, Clearwire, CLEAR, MetroPCS, Cricket, U.S. Cellular, Qwest Wireless, C Spire Wireless, Alltel, Cincinnati Bell Wireless, nTelos, Frawg, SouthernLINC, Movida Wireless, GCI Wireless, CGI Network, Alaska DigiTel Network, Bluegrass Cellular, Alaska Communications Systems, any suitable combination and the like.

The electronic locking device 10 may be used in many applications such as, without limitation, in the protection of heavy machinery and tools on construction sites, in the protection against intrusion, in the protection of construction materials, in the protection of containers and the like. The electronic locking device 10 may also be used with bicycles, motorcycles, boats, and to any goods which can be secured using conventional locking devices.

According to another embodiment, the mobile communication device 20 may include, without limitation, at least one of a wireless mobile communication device, a cellular mobile communication device, a radio frequency (i.e., RF) communication device and the like for providing a large diversity in the operation of the electronic locking device 10.

It is to be noted that the external network 24 may send the advisory messages 26 upon tampering with at least one of the closed electrical circuit 18, the mobile communication device 20 and the locking mechanism 12 directly to a user, via a sms communication for example, or to a supporting software. After analyzing a plurality of advisory messages 26, the software may generate a plurality of different kinds of reports to a user. For example, the report may include a time period, external weather data and movement detection data, time of the advisory messages, electronic locking device activation events, electronic locking device deactivation events, video events and the like.

According to another embodiment, the mobile communication device 20 of the electronic locking device 10 may be linked with an alarm system (not shown) such as to inform its user of the tampering.

According to another embodiment, the electrically conductive link 14 may include a sealant material at its ends 52, 53, thereby allowing the electronic locking device 10 to be watertight.

While preferred embodiments have been described above and illustrated in the accompanying drawings, it will be evident to those skilled in the art that modifications may be made without departing from this disclosure. Such modifications are considered as possible variants comprised in the scope of the disclosure.

1. An electronic locking device for securing goods comprising:
a locking mechanism;
an electrically conductive link used for forming a closed loop to the locking mechanism for securing the goods and for forming a closed electrical circuit; and
a mobile communication device connected to the closed electrical circuit and being in communication with at least one of a plurality of access points of an external network, the external network sending an advisory message upon tampering with at least one of the closed electrical circuit, the mobile communication device and the locking mechanism.

2. The electronic locking device of claim 1, further comprising a casing comprising a main frame and a cover portion releasably connected to the main frame, the main frame receiving the locking mechanism and at least a portion of the electrically conductive link on one side and the mobile communication device on another side, the cover portion for covering at least one of: the locking mechanism, the at least a portion of the electrically conductive link and the mobile communication device.

3. The electronic locking device of claim 1, further comprising an electronic circuit board for receiving at least one of: the locking mechanism, at least a portion of the electrically conductive link and the mobile communication device.

4. The electronic locking device of claim 3, further comprising a power supply integrated on the electronic circuit board.

5. The electronic locking device of claim 3, wherein the electronic circuit board further includes a power supply status indicator for indicating a power proportion remaining for operating the electronic locking device.

6. The electronic locking device of claim 5, wherein the power supply status indicator comprises a LED.

7. The electronic locking device of claim 1, wherein the locking mechanism comprises one of: a mechanical locking mechanism, an electromechanical locking mechanism, a digital locking mechanism, a removable key locking mechanism, a combination locking mechanism, a magnetic locking mechanism, a card reader locking mechanism, a cam locking mechanism, a child safety locking mechanism, a keycard locking mechanism, a time locking mechanism and any combination thereof.

8. The electronic locking device of claim 1, wherein the electrically conductive link comprises:
an internal cable having two ends to be coupled with the locking mechanism, the internal cable defining a length;
an electrically conductive cable for at least partially covering the internal cable along its length, the electrically conductive cable for forming the closed loop to the locking mechanism and for forming the closed electrical circuit; and
a protective cable for covering the internal cable and the electrically conductive cable, the protective cable being made of a material defining high strength properties.

9. The electronic locking device of claim 1, wherein the internal cable is made of a lifting cable and further wherein the material of the protective cable comprises a para-aramid synthetic fiber.

10. The electronic locking device of claim 1, wherein the external network allows sms communication, radio frequency communication and cellular communication.

11. The electronic locking device of claim 1, wherein the mobile communication device further includes a GSM card for storing and communicating information with the external network.

12. The electronic locking device of claim 1, further comprising a GPS integrated device on one of: the locking mechanism, at least a portion of the electrically conductive link and the mobile communication device.

13. The electronic locking device of claim 1, further comprising a communication push button for communicating information in real time with the external network.

14. The electronic locking device of claim 1, wherein the mobile communication device further includes a mobile communication indicator for indicating a mobile communication reception level for operating the electronic locking device.

15. The electronic locking device of claim 1, further comprising an alarm device connected to the mobile communication device for emitting an alarm when the external network sends the advisory message upon tampering with at least one of the closed electrical circuit, the mobile communication device and the locking mechanism.

16. The electronic locking device of claim 1, wherein the mobile communication device comprises at least one of: a wireless mobile communication device, a cellular mobile communication device and a radio frequency communication device.

17. An electronic locking device for securing goods comprising:
a locking mechanism;
an electrically conductive link used for forming a closed loop to the locking mechanism for securing the goods and for forming a closed electrical circuit; and
an electronic circuit board for electrically connecting the locking mechanism and the electrically conductive link, the electronic circuit board having:
a mobile communication device connected to the closed electrical circuit and in communication with at least one of a plurality of access points of an external network, the external network sending an advisory message upon tampering with at least one of the closed electrical circuit, the mobile communication device and the locking mechanism; and
a power supply for operating the mobile communication device.

18. The electronic locking device of claim 17, wherein the mobile communication device comprises at least one of: a wireless mobile communication device, a radio frequency communication device and a cellular mobile communication device.

19. An electrically conductive link for forming a closed loop to a locking mechanism of an electronic locking device for securing the goods, the electrically conductive link comprising:
an internal cable having two ends to be coupled with the locking mechanism, the internal cable defining a length;
an electrically conductive cable for at least partially covering the internal cable along its length, the electrically conductive cable for forming the closed loop to the locking mechanism and for forming a closed electrical circuit; and
a protective cable for covering the internal cable and the electrically conductive cable, the protective cable being made of a material defining high strength properties.

20. The electrically conductive link of claim 19, wherein the material of the protective cable comprises a para-aramid synthetic fiber.
